(19) United States
(12) Patent Application Publication
(10) Pub. No.: US 2019/0266676 A1
(43) Pub. Date: Aug. 29, 2019

(54) A SYSTEMS FRAMEWORK & HYDRODYNAMIC ANALOGY FOR ACCOUNTING ANIMATION

(71) Applicant: Grahame CRAIG, Hamilton (NZ)

(72) Inventor: Grahame CRAIG, Hamilton (NZ)

(21) Appl. No.: 16/068,900

(22) PCT Filed: Jan. 11, 2016
(86) PCT No.: PCT/IB2016/050098

§ 371 Date: Jul. 10, 2018

(51) Int. Cl. G06Q 40/00

(52) U.S. Cl. CPC G06Q 40/128

(57) ABSTRACT

A universal accounting framework with two manifestations—the MoneyMappa and the MoneyPlumba. The two manifestations afford a top-down outside-in perspective on the business as a dynamic financial system. In other words they provide the non-accountant with a helicopter view of the business financials. In forestry terms—they get to see all of the trees from above—a much better viewpoint for forestry managers. Businesses managers are no different in needing the same helicopter perspective.

### TECHNICAL FIELD

The two preferred embodiments of the invention (viz., the MoneyMappa and the MoneyPlumba) use computer graphics and animations to provide a deeper understanding of businesses as dynamic financial systems.

This understanding facilitates more effective management of any business by non-accountant owners, managers and directors. The invention is also a powerful educational tool for the aforementioned parties and for accounting students.

The MoneyMappa (see FIG. 2) is derived from re-casting (or mapping) the traditional accounting framework from its historical and static book-keeping format into an overview structure consisting of up to 12 defined groups of like accounts and their balances. Every account is assigned a unique home within one of the 12 groups.

The resultant 12-part structure can be used as a universal format, into which the chart of accounts (and the associated account balances) of any business can be mapped—giving rise to the Dynamic Balance Sheet (see FIG. 2).

The Dynamic Balance Sheet, displays the grouped account balances sequentially over time as as a changing set of balance sheets in bar graph form.

Each set of bar graphs portrays the balance sheet at one point in time. As time passes the bars move up or down as the system progresses through each successive time period.

This affords the user with a visual insight into any early signs of distortion in the either the liquidity or profitability of the business.

The MoneyMappa also provides a platform for the generation of a whole family of secondary graphs (time series or pie charts) of any individual account balance, or group of account balances. Included also is a full range of financial Key Performance Indicators (KPI's) derived from the sequential balance sheets and graphed as time series in each instance.

The MoneyPlumba (see FIGS. 3 to 5) uses the same 12 account groups as defined for the MoneyMappa but is coupled with an hydrodynamic analogy whereby money is portrayed as water. As a result those 12 account groups are transformed into 6 Tanks (the Assets) and 6 Wells (the Liabilities).

The former are shown as being above ground, being the physical manifestation of the business. The latter are shown as being below ground, being the financial, market, econonomic and equity environments of the business. All are interconnected by a system of pipes and taps.

The foregoing reflects the fact that the Wells are typically sources of water (money) while the Tanks are typically destinations for water (money).

There is a complete one-to-one corrspondence between the abstract concepts of accounting and the real-world components of the this hydrodynamic analogy (Ref FIG. 7)

The animations of the hydrodynamic analogy are generated using liquid physics software.

### BACKGROUND ART

Most patents in the accounting field, prior to the advent of distributed computing and the internet, describe accounting machines and related mechanical or electric devices. More recently patents have been filed for accounting games (in the form of physical board games or computerised versions thereof) for amusement and/or educational purposes.

Searches of databases available on WIPO, and patent offices in the USA, Australia and New Zealand have returned the following most relevant patents:

### U.S. Pat. No. 6,029,159: Zorba, Alexander et al; Pub. Date: February 2000 Title: System, Method & Article of Manufacture for a Simulation Enabled Accounting Tutorial System

A goal-based learning system using a rule-based expert training system to provide a cognitive educational experience, in a simulated environment that presents a business opportunity to understand and solve optimally. The system uses an artificial intelligence engine driving individualised dynamic feedback with synchronised video and graphics to simulate the real world. An accounting tutorial system is enabled to provide coaching on the book-keeping aspects of cost accounting. It his strongly oriented towards interactive and intelligent learning approaches using multi-media technology. A systems approach is used in the design of the learning feedback loop which is a dominant feature of the invention. Its overall framework extends well beyond accounting to encompass hardware and software components. The accounting component is reflected in the invention at the disaggregated transactional level, as per the traditional accounting model. No attempt is made to apply a systems approach to this aspect, or to the financial structure of the business itself.

### US PATENT US97/020775; Cashflow Technologies Inc., Pub Date: September 2000. Title: Board Game for Teaching Fundamental Aspects of Personal Finance, Investing & Accounting

Describes a board game for teaching fundamental aspects of personal finance, investing and accounting. Consists of the game board with two tracks (Rat Race and Fast Track respectively). Beginners use the former. The game card is partitioned 4 ways into a combined Income Statement (2 parts) and Balance Sheet (2 parts). Players progress along the track according to the roll of die. The Rat Race track has landing spaces which present financial obstacles and opportunities. The Fast Track is only accessible after a Rat Race player's passive income exceeds expenses. The invention does not step outside the boundaries and limitations of traditional accounting concepts and processes. The game provides a range of versions based on common professions (e.g., doctor, lawyer, etc).

### U.S. Pat. No. 7,736,148: Frampton, Peter Lawrence; Pub Date: August 2006 Title: Method of & Means for Teaching Accounting Concepts & Procedures

Describes a computer-based method for teaching accounting concepts and procedures. This invention takes the traditional book-keeping framework and portrays it visually. It focuses on the key concepts of assets, liabilities, income and expenditure, to build a visual grid divided into 4 uniquely coloured partitions (one for each of the above 4 concepts). Other components include coloured tickets and coloured buckets. The buckets signify accounts and the tickets signify transactions. Two distinct colours are used to differentiate between buckets representing the accounts of ownership (assets=green) from those representing the accounts of owing (liabilities=yellow). Terms other than the traditional accounting ones are used to denote accounting concepts. A screen journal diary is kept of the narrative for each transaction to be processed by the student. The traditional tabular reports of balance sheet, income statement and cash statement can be generated by the student at any stage. Decision trees are provided to aid the student to correctly process each transaction ticket.

### PCT PATENT 11308014—Gikandi, David Cameron Pub Date: December 2006 Title: Object-Oriented Visual Accounting System

Describes an object-oriented visual accounting system. The system integrates current accounting principles and software. It enables accounting tasks to be handled the same way that they are in real life. It is based on a time-line on which accounts (=moneycell objects) are displayed as and when they are affected by transactions (=money events) which are also displayed on a timeline. It offers a highly disaggregated view of the accounting process over time. Each moneycell can be assigned properties (including their balances), and being timeline based the system can be used for forecasting as well as historical accounting. Overall the object-oriented approach mirrors the style found in object-oriented computer programming software. No attempt is made to classify or group the moneycell objects according to the dynamic behaviour of each. No evidence is offered of it working in the context of a live business environment.

### Unpatented-Published Article: the Economy Machine by Serdar Ongan; the Journal of American Academy of Business, Vol 11 No. 1, December 2008, USA

This article describes the Phillips Machine, invented in the 1940's by NZ-born economist A. W (Bill) Phillips (also the inventor of the “Phillips Curve”). While teaching at the London School of Economics Phillips built a pedagogic machine to enable students to better understand the complex interactions between several macro-economic variables. In the absence of any modern-day computers with visual display capability he was left with no alternative but to physically build a machine (2 metres by 1.2 metres) comprising coloured water flowing through transparent pipes, in and out of several transparent tanks. He named this machine the MONIAC (Monetary National Income Automatic Computer)—inevitably re-christened the MANIAC to reflect the extraordinary and crazy analogy Phillips had drawn. The first version was built in a garage in 1949 from parts of an old fighter plane. (A MONIAC stands in the foyer of the Reserve Bank offices in Wellington, NZ). The machine visually modelled the economy as a dynamic system of money-flows, representing macroeconomic variables such as Consumption, Savings, Govt Expenditure, Investment, Taxation, Exports, and Imports—and their collective effects on Income.

None of the above prior art examples address the business as a dynamic system of money-flows, nor do they step beyond the book-keeping perspective of traditional accounting—other than to portray it visually either as a physical board game, or as an interactive computerised system. The disaggregated Chart of Accounts of traditional accounting is accepted without change.

No attempt is made to re-cast the Chart of Accounts into a systems framework predicated on the business structure itself as a financial system of money-flows. With the exception of the Moniac no attempt is made to use physical analogy beyond static game boards and/or diagrams.

The MONIAC is an exception in that it uses the analogy of hydrodynamics, (albeit applied to a national economy as opposed to a single business unit), and is obviously based on macro-economic principles rather than those of accounting. Had modern computer graphics and animation technology been available, Phillips would almost certainly have developed a virtual machine rather than a physical one in order to capitalise on this technology. His objectives were to use visual means combined with an everyday real-world physical analogy, to convey a better understanding of the dynamics of complex multi-variate interactions of the economy over time. His hydrodynamic analogy took economics out of its static and highly abstract straitjacket which unfortunately was a move too far ahead of its time to be practical.

The preferred embodiments of the invention described in the following pages take the same path—but in the context of the business as a system of money-flows and accounting as the accepted methodology for keeping track of those flows. There is one notable exception however. The MONIAC could have been simplified and designed more along the lines of system dynamics principles, by defining the water reservoirs as either tanks or wells, rather than all being designated as tanks. In fact the MoneyMappa/MoneyPlumba embodiments of this invention could be used to more effectively achieve Phillips' laudable aims for the MONIAC. In other words, a macro-economic embodiment of the invention is a possibility.

The extensive use by Zorba, et al of intelligent multi-media coupled with a sophisticated feedback learning loop are features which could readily be incorporated into the MoneyPlumba embodiment of the invention to further enhance it as an educational tool for non-accountants and students of accounting

Businesses are complex financial systems. Effective management of them requires information systems which recognise this. The power of infometrics, computer graphics, visual animations and physical analogy are well-proven ways of making the complex comprehensible.

The building industry, for example is totally dependent on building plans and elevations as a visual means of specifying the nature and design of any building and getting approval for its construction. Columns of measurements in place of visual plans is just not an option.

The accounting profession has largely failed to address the communications barrier that exists between itself and its SME customers—because it hasn't taken full advantage of present-day information and computer technologies. Its only foray into the latter has gone little beyond automating the book-keeping process.

In marked contrast, over 40 years ago the medical profession gave up writing its prescriptions in Latin, in direct response to a widely perceived need of their patients to be given their medical information in an understandable form—with the consequent removal of a long-standing doctor-patient communications blockage.

The accounting profession must surely have a similar obligation to deliver its information in the style and format most suited to its customers rather than in the style and format it prefers for itself.

The motivation for this invention and its use of computer graphics technology and analogy is a direct response to this unsatisfactory state of affairs.

### DISCLOSURE OF INVENTION

### Brief Description of Drawings

(Note: Secure links to narrated videos of both the MoneyMappa and MoneyPlumba embodiments of the invention are available on request)

FIG. 1 illustrates the two distinctive cognitive preferences of left-brain and right-brain respectively. While recent scientific research has shown this to be an over-simplification, empirical evidence does suggest there is a significant communications blockage between many providers of accounting information and those expected to use and benefit from that information, particularly in the small to medium (SME) business sector. (In-house accountants are a relative rarity among SME's—leaving their owners and managers to their own devices as regards explanation and interpretation of their accounting reports).

FIG. 2 shows the MoneyMappa framework and its core elements of 12 Account Groups with a superimposed composite bar graph (the Dynamic Balance Sheet). Bar graph animation parameters are user-specifiable via the control panel at the left side of this image. The device is essentially a graphics engine designed to be driven by either live or sample accounting data.

FIG. 3 shows the MoneyPlumba adaptation of the above framework. It uses the same 12 core elements as the MoneyMappa, but the superimposed balance sheet bar graph is replaced with an hydrodynamic analogy of the balance sheet. This analogy is manifested as a series of 6 Tanks and 6 Wells with interconnecting pipes. (In this representation the business shown is one that has never traded, as all Tanks are empty and all Wells are full).

FIG. 4 shows the essence of the hydrodynamic analogy, in the context of the simplest possible business entity—a roadside stall. All the essential features of the analogy are demonstrated by animating four simple transactions, with effects displayed as per FIGS. 4A, 4B, 4C & 4D.

FIG. 5 shows the full-scale version of the MoneyPlumba after “playing” the first 10 transactions being those typically associated with starting up a business from nothing, through to full trading status. For illustrative purposes all transactions amounts are in multiples of $1,000. (Note that in the interests of simplicity no GST (Transactional Tax) money-flow components of any transaction are shown).

FIG. 6 Sets out the detailed description of the 25 transactions used in FIG. 5.

FIG. 7 shows in list form, each of the the traditional mainstream accounting terms, with the equivalent “MoneyPlumba” term alongside it.

FIG. 8 shows how the invention fits with traditional accounting by providing the missing second side to the accounting “coin”.

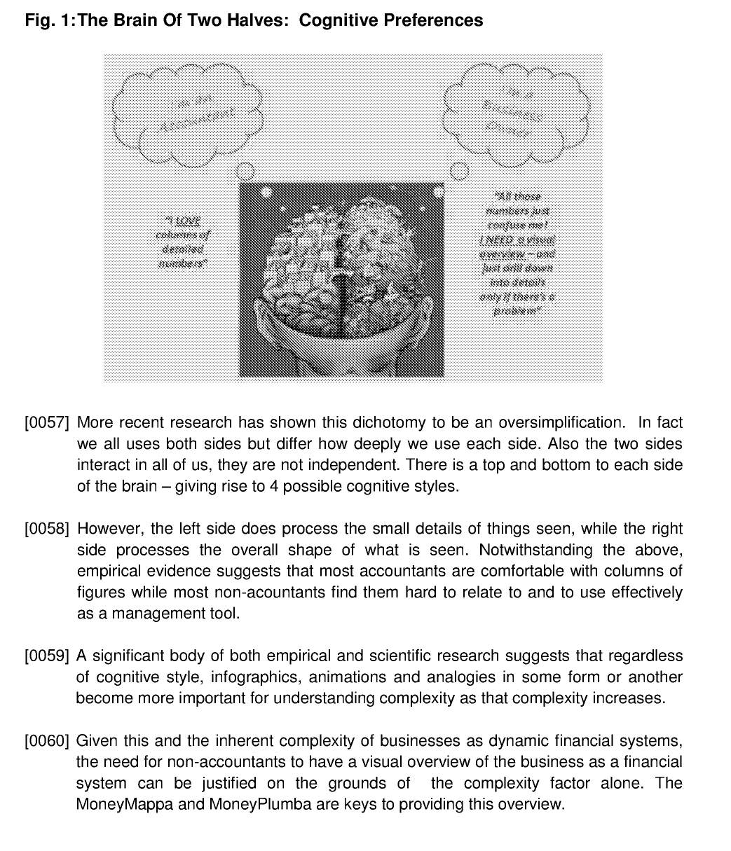

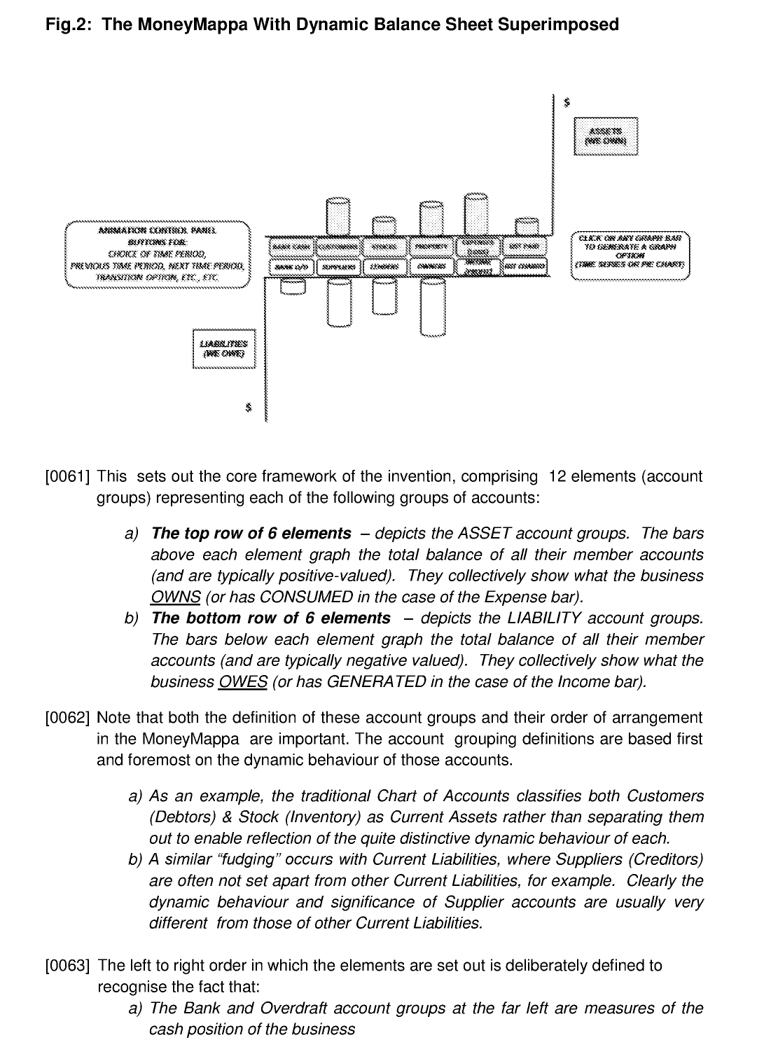

### MODES FOR CARRYING OUT THE INVENTION

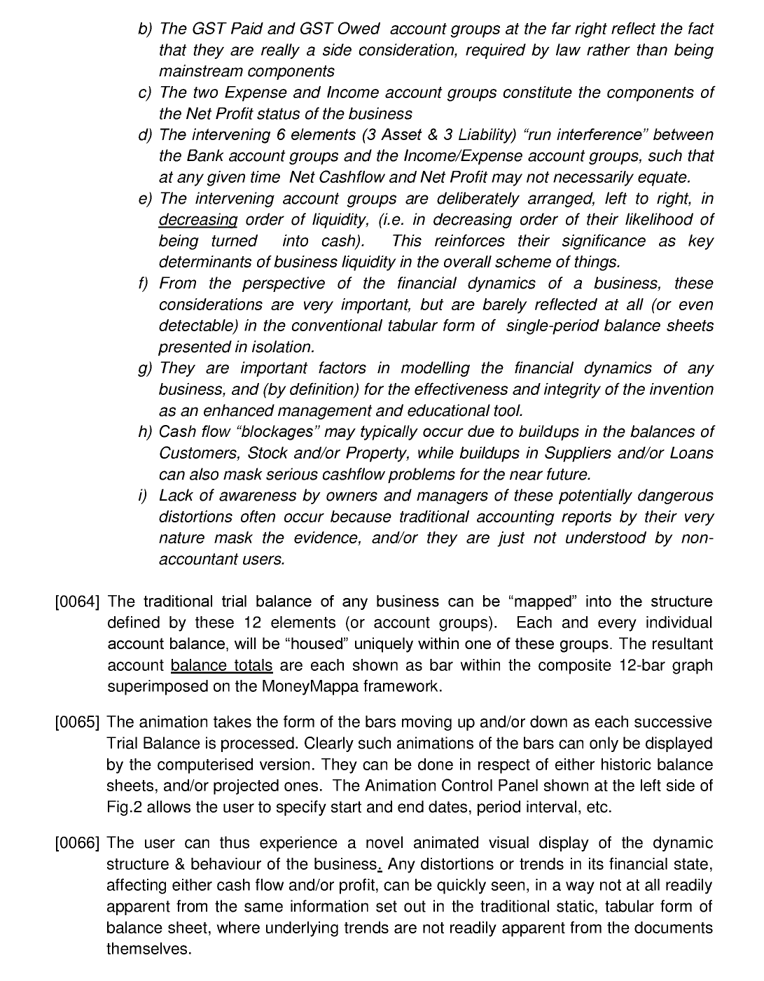

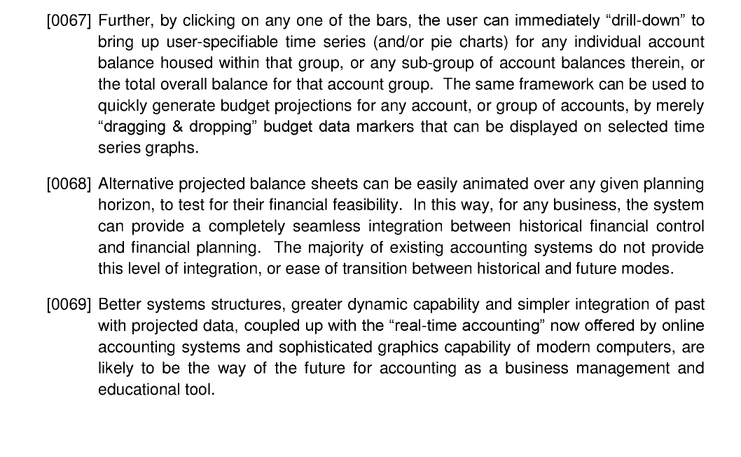

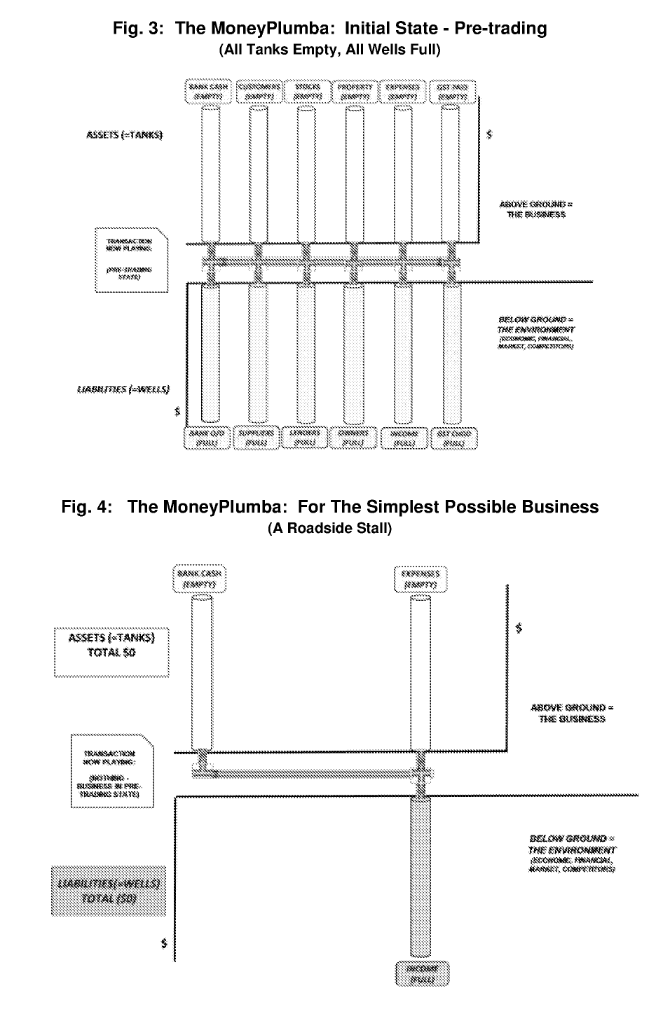

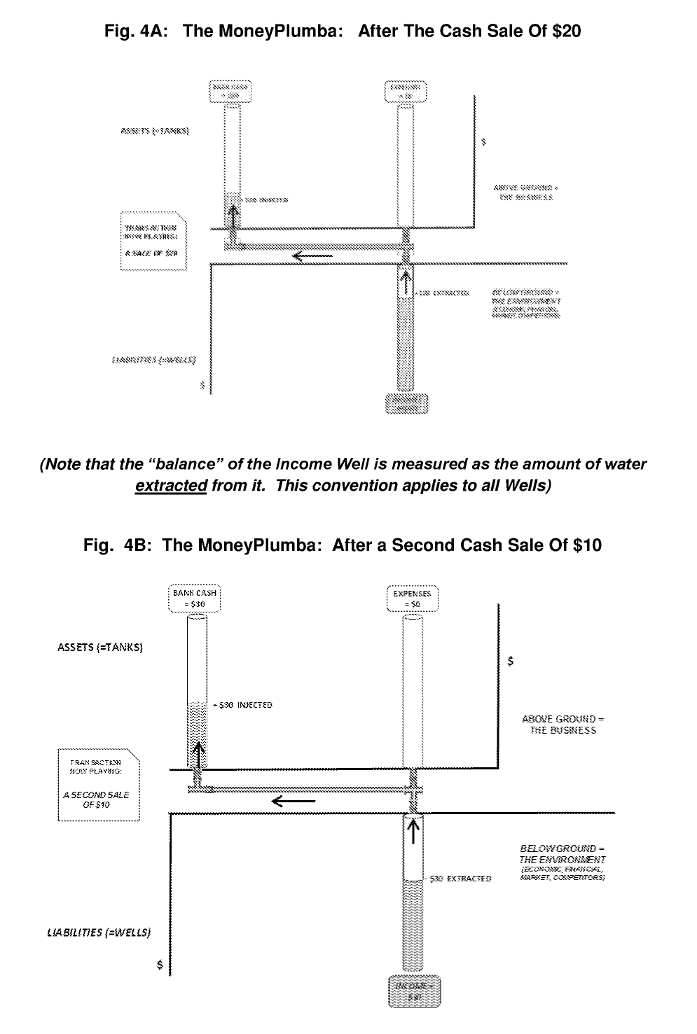

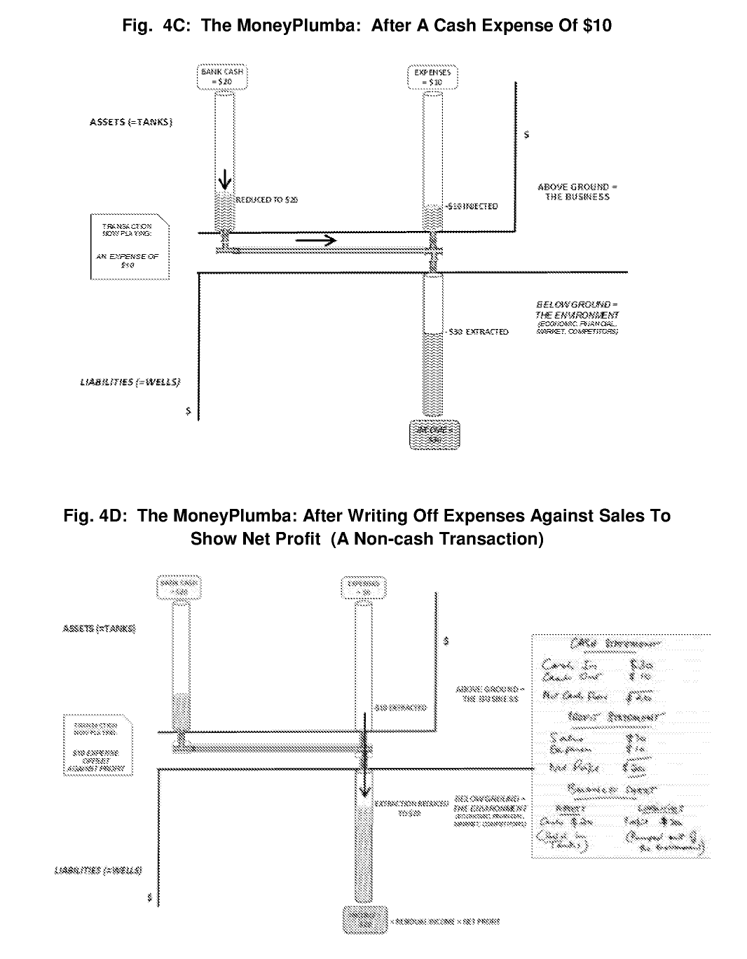

The invention has two primary modes. First is the MoneMappa mode (see FIG. 2) which serves to import and map live business transactions (either historical or forecast) into its universal framework. It then generate a series of dynamic bar graphs from those mapped account balances. The time interval between successive bar graphs is user specifiable, ranging from monthly through to quarterly or yearly.

This enables the user to quickly spot the early stages of any deterioration (either historical or forecasted) in the financial stability and/or profitability of the business. For most non-accountant managers, owners and directors, the balance sheet in its traditional tabular form tells them little. This is unfortunate as it is the only accounting report which tells everything about the financial state of the business—particularly in regard to its liquidity and profitability (or lack of it). It is an empirical fact that in the developed economies more SME's fail through poor cash management than any other reason.

It also provides a platform for generating a family of secondary graphs covering (at the user's option) a time series graph or pie chart of any account balance or group of account balances. These optional graphs also include time series for key financial performance indicators (KPI's).

An extended mode for the MoneyMappa embodiment of the invention is its application as a universal accounting framework for business sector benchmarking surveys and comparative analyses. These typically involve ranking individual businesses within any given sector according to their performance against a defined set of financial Key Performance Indicators (KPI's) being achieved for the sector as a whole. The rankings are made on the basis of comparisons of each individual business against the sector median, average, upper quartile and lower quartile benchmarks.

The second mode of the invention incorporates the hydrodynamic analogy afforded by the MoneyPlumba. In this mode any individual transaction (or sequence of transactions) can be animated to show precisely how each affects the balance sheet as a money flow from a source Tank (or Well) to a destination (Tank or Well).

Over time the user can build a strong mental model of how money flows into, around and out of the business as well as exactly how those flows alter account balances. The user also learns to associate each such flow with its accounting name.

Further, those important abstract concepts of “debits” and “credits” can readily be seen as being money inflows and money outflows, respectively.

The 500 year-old “Double Entry Principle” of traditional book-keeping can be re-stated (from the business' perspective) as being simply that every money outflow gives rise to an equal money inflow. In other words there are no money leakages. A systems re-statement of this above principle, would therefore be the “Exit-Entry Principle” or the “Closed System” principle.

The MoneyPlumba's primary use is as an educational tool. Few non-accountants are aware that there are only 25 transaction types that commonly occur in businesses. Each of these transactions can be animated by the MoneyPlumba.

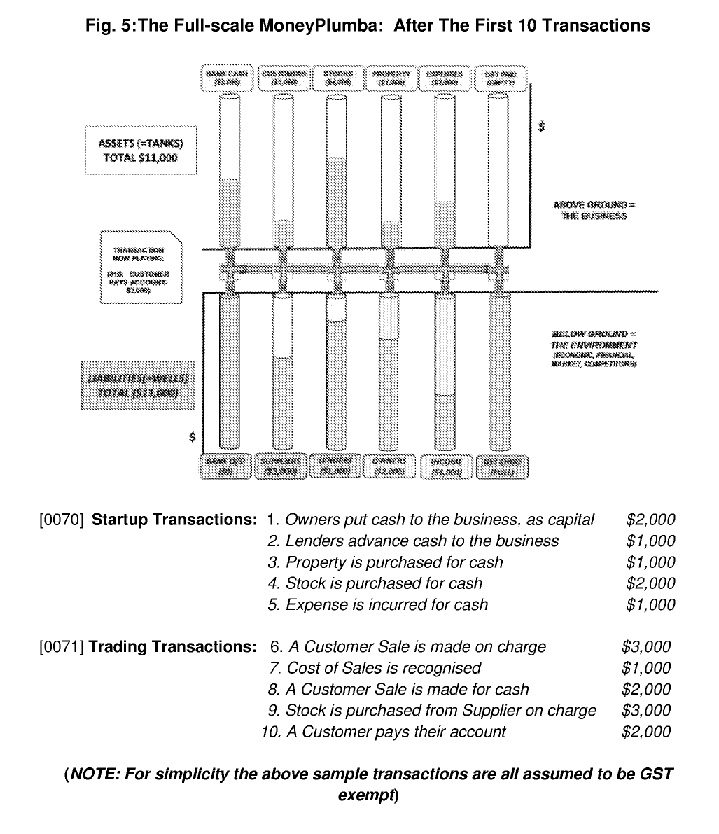

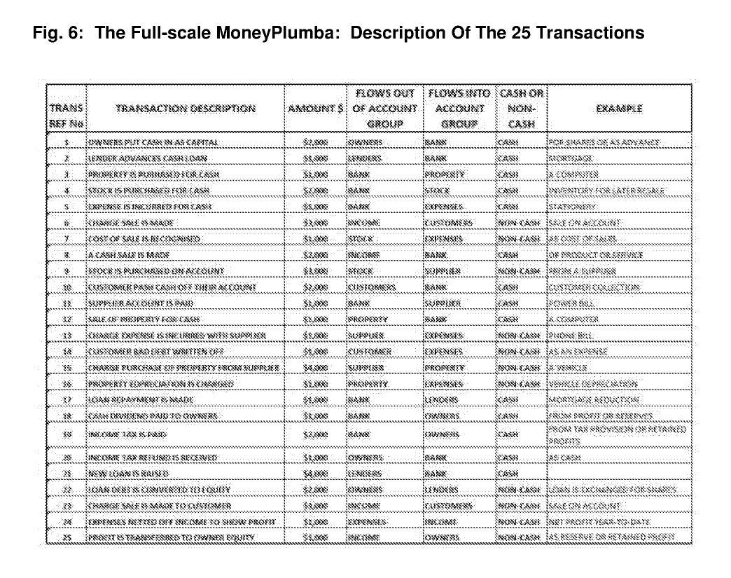

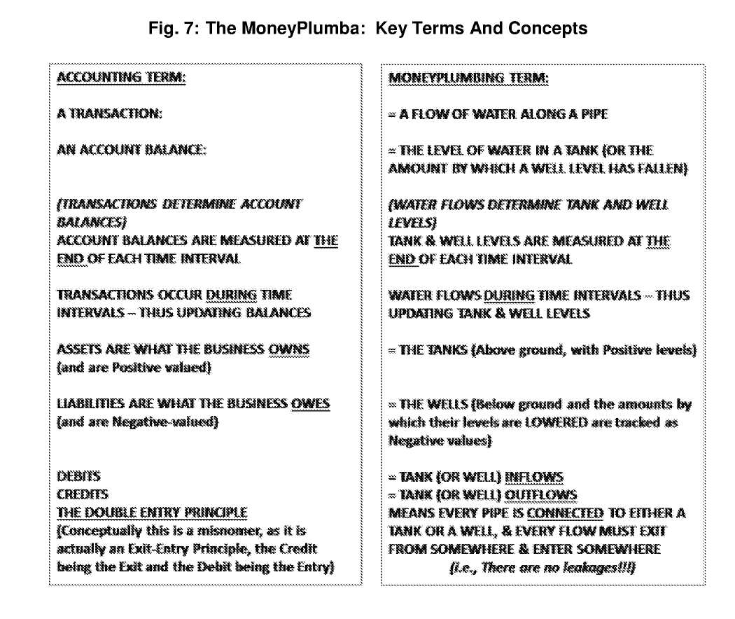

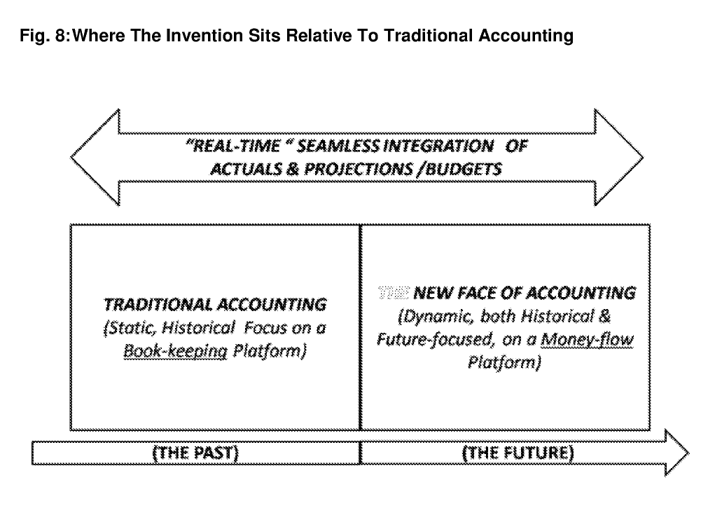

FIG. 5, shows the result after the first 10 of these 25 transactions have been played through the system. Their order of precedence is that which would typically be associated with starting a business from nothing, through the setup phases to full trading status. This in itself is a useful educational feature. In addition the user gets to know precisely what each of the 25 transactions really means, which of them are cash transactions and which are non-cash transactions, why and how net cashflow may differ from net profit over any given time interval and how each affects the balance sheet.

The MoneyPlumba turns the black box of traditional accounting, (rooted in its static book-keeping straitjacket and abstract concepts) into a glass box with visible moving parts that have both a clear physical meaning and a corresponding accounting meaning. It does this by morphing that book-keeping structure into a business-focused systems structure, coupled with the everyday physical analogy of hydrodynamics.

Both of the manifestations of the invention described above can over time build the non-acounting user's mental model of the business as a financial system in a way which is not possible under the black box scenario of traditional accounting.

The MoneyPlumba can readily be adapted for use as a platform for an interactive computer (or mobile app) based business game. This, in its simplest format, would pit a lone “business owner” player against an environment comprising computer-generated economic, financial, market, competitor and equity sectors.

An extended non-business mode of use for both the MoneyMappa and MoneyPlumba embodiments would be their adaptation to a macro-economic context. This would effectively constitute a modern-day upgrade of the MONIAC invention.

The need for better communication and understanding of the complexities of businesses as financial systems, also applies to economies. In fact it could be argued that the need is even greater as the performance of a whole economy clearly has a much wider and more direct impact on the lives of a nation's citizens than the business sector alone.

The 6×6 account group structure and the concepts of assets (owning) and liabilities (owing) being represented as Tanks and Wells respectively, are clearly applicable at a national economy level albeit in modified form. The economy is also a closed system characterised by money flows into, around and out of it. Basic economic concepts, relationships and effects could be easily displayed as computer animations—sufficiently well to impart a better understanding of economic fundamentals and policy effects than exists at present.

1. The preferred embodiment of the invention delivers a universal accounting framework with two manifestations—the MoneyMappa and the MoneyPlumba. They share the following common attributes—

2. Both afford a top-down outside-in perspective on the business as a dynamic financial system. In other words they provide the non-accountant with a helicopter view of the business financials. In forestry terms—they get to see all of the trees from above—a much better viewpoint for forestry managers. Businesses managers are no different in needing the same helicopter perspective.

3. In contrast, traditional accounting reports only offer a view from the forest floor —or worse for many non-accountants, no view at all. As a result most of them are left “unable to see the forest for the trees”.

4. The invention thus paves the way for non-accountants and accounting students to form a clear and coherent mental model of the business as a financial system—by turning the black box of accounting into a glass box.

5. Together the MoneyMappa and MoneyPlumba bring accounting to life. In an increasingly complex and world, this represents a quantum shift for accounting. From being largely confined to an historical straitjacket, which is now totally automated, it needs to liberate itself by embracing a new systems-based future-oriented perspective.

6. This invention carries the potential for realising exactly such a quantum shift.

7. Both manifestations of the invention can be delivered to users over the internet or as mobile apps.
Specifically, the MoneyMappa will:

8. Provide an innovative, coherent and rigorous systems view of the balance sheets of any business—courtesy of its Dynamic Balance Sheet animations.

9. Visually animate sequential balance sheets in overview form, for any business over any time interval—past and/or projected.

10. Enable the quick generation of a family of user-specifiable time series graphs and pie charts covering any account balance, or group of balances, along with the most important financial ratios and Key Performance Indicators (KPI's).

11. Enable seamless real-time integration of historical and projected financial data and the quick testing of alternative futures and strategies for any business. (Effective forecasting is best done on an aggregated top-down basis in contrast to the bottom-up aproach of historical accounting).

12. Complement and enhance traditional accounting reports.

13. Facilitate management by exception, by allowing users to see the big picture first, quickly identify problem areas, then “drill down” for the detail.

14. Provide non-accountants in general with a better understanding of accounting and how it works—from its transactional to its balance sheet levels.

15. Better enable business owners, managers, directors and students to appreciate and use accounting as a management tool.

16. Link into any live accounting database to upload sequences of Trial Balances on a regular basis e.g., monthly, quarterly and/or annually, by using the mapping software module appropriate to their accounting software.

17. The MoneyMappa's universal balance sheet structure can be used in business sector surveys and comparative analyses, e.g., financial data from all dentists, who (regardless of their accounting system) could map their Trial Balances into a common benchmarking database of dental practices.

18. From this a host of sector statistics & financial KPI's can be generated as a basis for each individual participant to be benchmarked against the sector as a whole. Specifically the MoneyPlumba will:

19. Put a physical face on the abstract concepts of traditional accounting with a real-world system of Tanks, Wells, interconnecting pipes and taps, so that: a) Account balances become Tank & Well “water” levels.
b) Transactions become “water flows” along relevant pipes connecting any two Tanks and/or Wells —to update their respective “water” levels.

20. Animate any given financial transaction as a money (water) flow.

21. (canceled)

22 (canceled)

23 (canceled)

24 (canceled)

25. (canceled)

26 (canceled)

27 (canceled)

28 (canceled)

29 (canceled)
